(19) United States
(12) Patent Application Publication
(10) Pub. No.: US 2008/0259385 A1
(43) Pub. Date: Oct. 23, 2008

(54) COMMUNICATION APPARATUS, TRANSMISSION PROCESSING METHOD, AND RECEPTION PROCESSING METHOD

(75) Inventor: Kazuhiro Uruma, Kawasaki-shi (JP)

Correspondence Address: ROSSI, KIMMS & McDOWELL LLP., P.O. BOX 826, ASHBURN, VA, 20146-0826, US

(73) Assignee: CANON KABUSHIKI KAISHA, Tokyo (JP)

(21) Appl. No.: 11/943,510

(22) Filed: Nov. 20, 2007

(30) Foreign Application Priority Data
Nov. 22, 2006 (JP) 2006-316115
Jan. 24, 2007 (JP) 2007-014196

(51) Int. Cl. G06F 3/12

(52) U.S. Cl. 358/1.15

(57) ABSTRACT

A communication apparatus which is capable of preventing transmitted data from being illegally viewed or tampered with. Image information to be transmitted is input via an operating display section. A system controller determines whether or not confidential transmission of the input image information has been designated by the user. When it is determined that confidential transmission of the input image information has been designated, a network controller encrypts the input image information using IPsec and transmits the encrypted image information, whereas when it is determined that the confidential transmission of the input image information is not designated, the network controller transmits the input image information without encrypting the same.

### BACKGROUND OF THE INVENTION

1. Field of the Invention

The present invention relates to a communication apparatus which performs facsimile communication in real time via an IP network, and more particularly to a communication apparatus which performs real-time internet facsimile communication (IP-FAX communication) using a communication in which path-encrypted communication (IP security protocol communication) method in which communication is performed with encrypted IP packets, a transmission processing method, and a reception processing method.

2. Description of the Related Art

Conventionally, facsimile machines have been used as long-distance information communication means between offices. Some facsimile machines as long-distance information communication means use a PSTN line, which is an analog line, or an ISDN line, which is a digital line. Further, facsimile machines using the ISDN line include not only a type having a communication speed of 14.4 kbps set in accordance with ITU-T Recommendation T.30, but also a type capable of performing negotiation at a communication speed of 28.8 kbps set in accordance with ITU-T Recommendation V.34.

Recently, facsimile machines equipped with the IP-FAX (internet facsimile) communication function which use an IP (Internet Protocol) network, such as the Internet or an intranet, have been on the increase, due to their advantages of high-speed transmission capability and reduced communication fees. In IP-FAX communication, a facsimile signal is converted to IFP (Internet Facsimile Protocol) packets according to ITU-T Recommendation T.38, and then the IFP packets are transmitted onto a network, whereby image data transmission and reception are performed. During IP-FAX communication, data flows as IP packets on a network transmission path, and hence the data is in danger of being illegally viewed or tampered with. To protect data from the danger, a recent trend is to introduce encryption means using IPsec (Internet Protocol Security) which performs encryption and authentication of IP packets (see e.g. Japanese Laid-Open Patent Publication (Kokai) No. H10-327193 or a relevant RFC).

The IPsec incorporates a key exchange function, an authentication function, and an encryption function. The key exchange function is to safely exchange information on keys necessary for authentication or encryption. The authentication function is to perform authentication of a sender of IP packets by adding a header called an AH (Authentication Header) to the IP packets to thereby prevent a malicious third party pretending to be the authorized user from sending unauthorized packets. The encryption function is to add a header called an ESP (Encapsulating Security Payload) to each IP packet to thereby encrypt the entire packet including the ESP header or only the payload of the packet. Encryption of the entire packet is called the “tunneling mode”, and encryption of only the payload as “transport mode”. On the other hand, there has been proposed a technique in which a multi-line facsimile connected to both a public telephone line network and a LAN (Local Area Network) encrypts a confidential document for transmission (see e.g. Japanese Laid-Open Patent Publication (Kokai) No. 2001-211306). More specifically, when the multi-line facsimile receives the confidential document from another terminal via the public telephone line network, the confidential document is encrypted and sent to a server via the LAN. Then, the server transmits the encrypted confidential document via the LAN to a user terminal as a destination of the confidential document.

However, it is difficult to protect facsimile data from the danger of being illegally viewed or tampered with on a communication path connecting between facsimile machines at respective sending and receiving sides. Therefore, it is desired to secure the security of reliably protecting data transmitted and received by facsimile communication from the danger of being illegally viewed or tampered with.

Further, during the above-mentioned IP-FAX communication, it is difficult for a sending-side user to determine from a transmitted document whether or not the document has been sent to a destination without being illegally viewed or tampered with. Similarly, it is difficult for a receiving-side user to determine from a printed received document whether or not the document has been sent without the danger of being illegally viewed or tampered with on a transmission path.

Furthermore, it has been impossible to easily and conveniently visually recognize information peculiar to the IP-FAX communication based on the SIP+T.38 protocol, from a transmitted document or from a printed received document.

### SUMMARY OF THE INVENTION

The present invention provides a communication apparatus, a transmission processing method, and a reception processing method, which are capable of preventing transmitted or received data from being illegally viewed or tampered with.

Further, the present invention provides a communication apparatus, a transmission processing method, and a reception processing method, which enables users to easily know that image information has been sent with security.

In a first aspect of the present invention, there is provided a communication apparatus which is capable of performing communication via an IP network, comprising an image information input unit configured to input image information to be transmitted, a determining unit configured to determine whether or not confidential transmission of the input image information has been designated by a user, and a transmission unit configured to be operable when it is determined that the confidential transmission of the input image information has been designated, to encrypt the input image information using IPsec and transmit the encrypted image information, whereas when it is determined that the confidential transmission of the input image information has not been designated, to transmit the input image information without encryption. The communication apparatus further comprises an information-adding unit configured to add additional information indicative of execution of encrypted transmission using IPsec to the input image information when the input image information is to be encrypted and transmitted using IPsec.

The communication apparatus further comprises an image reading unit, and the image information input unit can input image information read by the image reading unit, as the image information to be transmitted.

In a second aspect of the present invention, there is provided a communication apparatus which is capable of performing communication via an IP network, comprising a reception unit configured to receive image information transmitted via the IP network, an encryption unit configured to encrypt the received image information, a storage unit configured to store the received image information, a determining unit configured to determine whether or not the received image information was transmitted using IPsec, and a controller unit configured to be operable when the determining unit determines that the received image information was transmitted using IPsec, to cause the image information to be stored in the storage unit after being encrypted by the encryption unit, whereas when the determining unit determines that the received image information was transmitted without using IPsec, to cause the image information to be stored in the storage unit without being encrypted by the encryption unit.

The reception unit can receive the image information transmitted after being encrypted using IPsec.

In a third aspect of the present invention, there is provided a communication apparatus which is capable of performing communication with a terminal unit at another end connected to the communication apparatus via an IP network, comprising an encryption unit configured to encrypt image information to be transmitted to the terminal unit at the other end, a determining unit configured to determine whether or not the image information is to be encrypted by the encryption unit for transmission, an information-adding unit configured to be operable when the determining unit determines that the image information is to be encrypted by the encryption unit for transmission, to add additional information indicative of execution of encrypted transmission to the image information, and a transmission unit configured to transmit the image information having the additional information added thereto and encrypted by the encryption unit to the terminal unit at the other end.

The communication apparatus further comprises a generation unit configured to generate the additional information, and the information-adding unit adds the additional information generated by the generation unit to a header area in the image information.

The transmission unit can perform real-time internet facsimile communication in accordance with ITU-T Recommendation T.38, to transmit the image information.

The encryption unit can encrypt IP packets generated based on the image information, in accordance with an IPsec protocol.

In a fourth aspect of the present invention, there is provided a communication apparatus which is capable of performing communication with a terminal unit at another end connected to the communication apparatus via an IP network, comprising a reception unit configured to receive image information transmitted from the terminal unit at the other end, a decryption unit configured to decrypt the image information received by the reception unit when the image information was encrypted, a determining unit configured to determine whether or not the image information received by the reception unit was encrypted, an information-adding unit configured to be operable when it is determined by the determining unit that the image information was encrypted, to add additional information indicative of execution of encrypted transmission to the image information decrypted by the decryption unit, and a printing unit configured to print the image information having the additional information added thereto.

The communication apparatus further comprises a generation unit configured to generate the additional information, and the information-adding unit adds the additional information generated by the generation unit to a footer area in the image information.

The reception unit can perform real-time internet facsimile communication in accordance with ITU-T Recommendation T.38, to receive the image information.

The decryption unit can decrypt encrypted IP packets generated based on the image information, in accordance with an IPsec protocol.

The features and advantages of the invention will become more apparent from the following detailed description taken in conjunction with the accompanying drawings.

### BRIEF DESCRIPTION OF THE DRAWINGS

FIG. 1 is a schematic view of a network including facsimile machines according to a first embodiment of the present invention.

FIG. 2 is a block diagram of a digital multifunction machine appearing in FIG. 1.

FIG. 3 is a view showing an example of an IP-FAX communication configuration screen displayed on the digital multifunction machine (sending-end machine) in FIG. 1.

FIG. 4 is a view showing an example of an IP-FAX communication configuration screen displayed on the digital multifunction machine (receiving-end machine) in FIG. 1.

FIG. 5 is a view showing an example of transmission-related information recorded in a transmission document when the IP-FAX communication is configured as shown in the screen in FIG. 3.

FIG. 6 is a view showing an example of reception-related information recorded in a received document when the IP-FAX communication is configured as shown in the screen in FIG. 4.

FIG. 7 is a flowchart of a transmission process in IP-FAX communication, which is executed by the digital multifunction machine (sending side).

FIG. 8 is a flowchart of a process executed by the digital multifunction machine (sending side), for recording the transmission-related information and a mark indicative of execution of IP-FAX communication using IPsec.

FIG. 9 is a flowchart of a receiving process in IP-FAX communication, which is executed by the digital multifunction machine (receiving side).

FIG. 10 is a flowchart of a process executed by the digital multifunction machine (receiving side), for recording a mark indicative of execution of IP-FAX communication using IPsec.

FIG. 11 is a schematic block diagram of a digital multifunction machine according to a second embodiment of the present invention.

FIG. 12 is a view of a sender record configuration screen displayed on the digital multifunction machine at a sending side, for configuration of a sender record by a sending-side user.

FIG. 13 is a view of a print information record configuration screen displayed on the digital multifunction machine at a receiving end, for configuration of a print information record by a receiving-side user.

FIG. 14 is a view showing an example of a sender record (header) added to a transmission document when IPsec communication is performed between the digital multifunction machines.

FIG. 15 is a view showing an example of a print information record (footer) added to a received document in printing of the document received when IPsec communication is performed between the digital multifunction machines.

FIG. 16 is a flowchart of a FAX sender record-generating process executed by the digital multifunction machine at the sending end.

FIG. 17 is a flowchart of a print information record-generating process executed by the digital multifunction machine at the receiving side.

### DETAILED DESCRIPTION OF THE PREFERRED EMBODIMENTS

The present invention will now be described in detail with reference to the drawings showing preferred embodiments thereof.

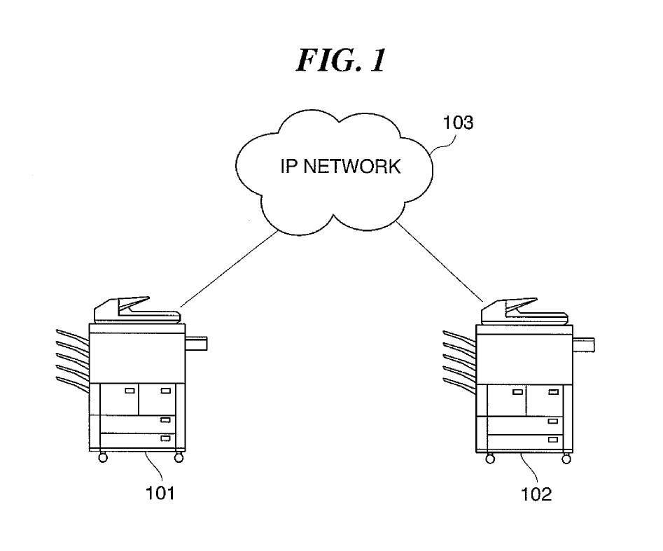

FIG. 1 is a schematic view of a network including facsimile machines according to a first embodiment of the present invention.

As shown in FIG. 1, the network includes an IP network 103 implemented by the Internet or an intranet. Connected to the IP network 103 are a plurality of digital multifunction machines 101 and 102 which are capable of performing IP-FAX communication using IPsec.

The IP-FAX communication using IPsec means a facsimile communication in which authentication of a sender is performed using the IPsec functions of key exchange, authentication, and encryption, and IFP packets formed based on an image read from an original are encrypted using IPsec and then transmitted. Now, it is assumed that IP-FAX communication using IPsec is performed e.g. between the digital multifunction machine 101 at a sending side and the digital multifunction machine 102 at a receiving side.

In this case, the digital multifunction machine 101 (sending side) generates a facsimile signal (a procedure signal or encoded image data). The facsimile signal is converted to IFP packets. At the same time, the IFP packets are encrypted according to IPsec. Then, the encrypted IPF packet are sent from the digital multifunction machine 101 over the IP network 103.

Upon reception of the encrypted IPF packets, the digital multifunction machine 102 (receiving side) decrypts the encrypted IPF packets into plaintext. Then, the plaintext IFP packets are converted into the original facsimile signal, i.e. the encoded image data. Further, in the present embodiment, the image data is encrypted using a predetermined encryption method and is stored in a memory. The encrypted image data in the memory is decrypted using a decryption key input by an associated user, and is then printed out.

As described above, in IP-FAX communication using IPsec, encrypted IFP packets are transmitted over the IP network 103. Therefore, the IP-FAX communication using IPsec makes it possible to prevent the facsimile signal from being illegally viewed or tampered with.

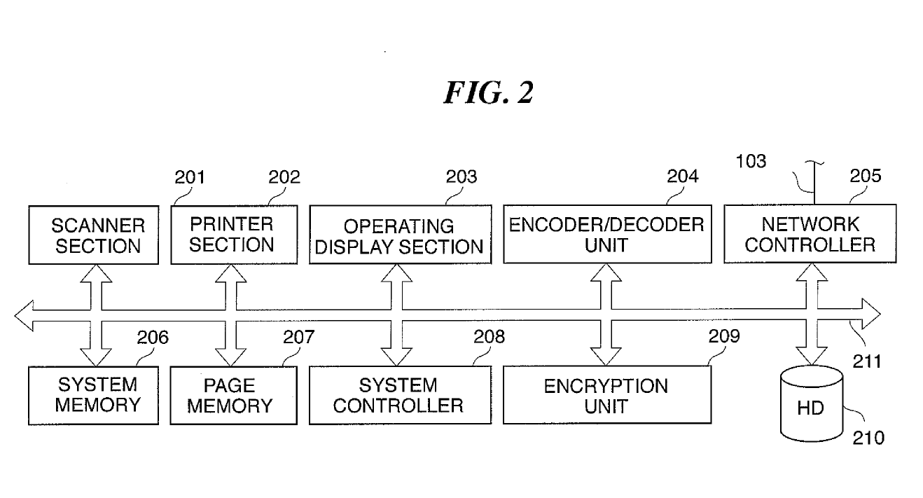

Further, at the receiving side, received image data is further encrypted and stored, and hence it is possible to protect the received image data from the danger of being illegally viewed or tampered with. Next, the configuration of the digital multifunction machine 101 (102) will be described with reference to FIG. 2. FIG. 2 is a block diagram of the digital multifunction machine 101 (102) appearing in FIG. 1.

As shown in FIG. 2, the digital multifunction machine 101 (102) includes a scanner section 201, a printer section 202, an operating display section 203, an encoder/decoder unit 204, and a network controller 205. Further, the digital multifunction machine 101 (102) includes a system memory 206, a page memory 207, a system controller 208, an encryption unit 209, and a hard disk (hereinafter referred to as “the HD”) 210. These blocks 201 to 210 are connected to a system bus 211.

The scanner section 201 reads an original in a designated reading mode (in which a sheet size, a resolution, a density, etc. are designated). The printer section 202 prints an image on a sheet and delivers the sheet onto a stacking tray via a sheet discharge apparatus (not shown), such as a finisher. The operating display section 203 includes an operation panel via which the user performs input operations for configuring various settings and a display panel which displays a set mode, details of the set mode, the operational status of the machine, and so forth.

The encoder/decoder unit 204 encodes image data read by the scanner section 201, for facsimile communication, and decodes a received facsimile signal (encoded image data) into original image data.

The network controller 205 establishes connection to the IP network 103 to perform facsimile communication with another apparatus on the IP network 103. In the present embodiment, normal IP-FAX communication which does not use IPsec and IP-FAX communication using IPsec are selectively performed as facsimile communication.

In IP-FAX communication, the network controller 205 performs various processes for call setup, capability declaration, image transmission, call disconnection, and so forth. In a state connected to a communication terminal on the IP network 103, the network controller 205 converts a facsimile signal including procedure signals and an image signal to IFP packets, and then transmits the IFP packets over the IP network 103. On the other hand, upon reception of IFP packets by IP-FAX communication, the network controller 205 reconverts the received IFP packets into an original facsimile signal.

During IP-FAX communication using IPsec, the network controller 205 encrypts IFP packets using IPsec and then transmits the encrypted IFP packet over the IP network 103. On the other hand, upon reception of the encrypted IFP packet, the network controller 205 decrypts the encrypted IFP packets into plaintext IFP packets and then converts the plaintext IFP packets into an original facsimile signal. As is apparent from the above, IP-FAX communication using IPsec is distinguished from IP-FAX communication without using IPsec in that encrypted IFP packets are transmitted and received, but they are identical in the operational procedure for carrying out processes, such as call setup, capability declaration, image transmission, call disconnection, and so forth.

The system memory 206 includes a ROM storing programs for controlling the machine and data required for control operations, and a RAM providing work areas for execution of control operations. The page memory 207 is used for loading one page of image data to be encoded or decoded. The system controller 208 includes a CPU (not shown) that controls the operations of the respective blocks 201 to 207, 209, and 210 via the system bus 211 according to the programs stored in the system memory 206.

The encryption unit 209 encrypts image data (encoded image data) received by normal IP-FAX communication performed without using IPsec or IP-FAX communication performed using IPsec, based on settings configured in advance. The encrypted image data is stored in the HD 210. Further, the encryption unit 209 has a function of decrypting encrypted image data into original image data (into plaintext). The cryptosystem that is used by the encryption unit 209 can be selected from various cryptosystems including a shared key cryptosystem, and a public key cryptosystem, but is not limited to any particular cryptosystem.

The HD 210 stores the encrypted image data (encoded image data), unencrypted image data (image data read by the scanner section 201, encoded image data, and decoded data), and so forth. Further, a reception box for storing specific received documents, such as confidential documents, can be provided in the HD 210 in association with an F code or a password (PWD) designated by a sender. For example, when image data with an F code or a PWD designated by a sender is received (i.e. in confidential communication), the received image data is stored in a reception box associated with the designated F code or PWD.

Next, a description will be given of a case where IP-FAX communication is performed between the digital multifunction machines 101 and 102, assuming that the digital multifunction machine 101 is at a sending side and the digital multifunction machine 102 at a receiving side. In the case of performing the IP-FAX communication, one of IP-FAX communication using IPsec and normal IP-FAX communication (IP-FAX communication without using IPsec) is selected and executed according to settings configured by the associated user.

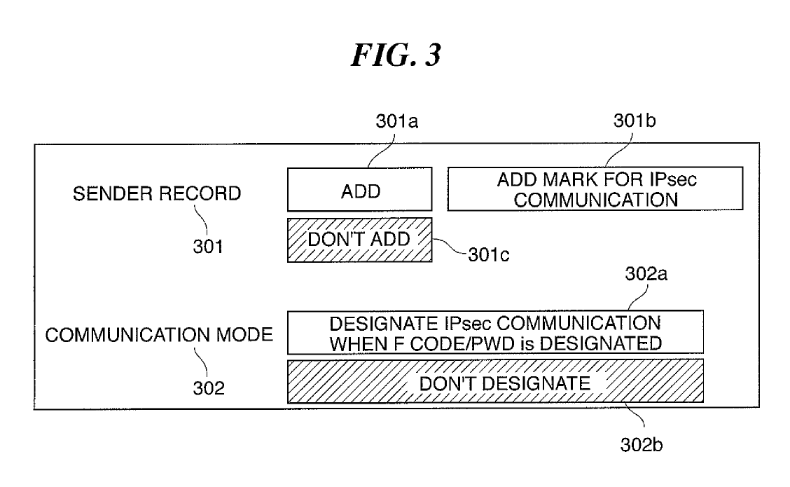

First, configuration of IP-FAX communication performed for the digital multifunction machine 101 (sending side) by the user will be described with reference to FIG. 3. FIG. 3 is a view showing an example of an IP-FAX communication configuration screen displayed on the digital multifunction machine 101 (sending side) in FIG. 1.

In the case of configuring the settings of IP-FAX communication, the IP-FAX communication configuration screen illustrated in FIG. 3 by way of example is displayed on the operating display section 203 in response to user operations input via the operating display section 203. Displayed on the IP-FAX communication configuration screen are a plurality of operation buttons 301a, 301b, and 301c for configuring a sender record 301, and a plurality of operation buttons 302a and 302b for configuring a communication mode 302.

Now, concerning the configuration of the sender record 301, the operation button 301a is provided for selectively setting the recording of transmission-related information, such as a transmission time and a sender's telephone number, in a document to be transmitted. The operation button 301b is made selectable when the operation button 301a has been pressed. When the operation button 301b is pressed, the sender record 301 is configured such that a mark indicative of the fact is added to the transmission document when IP-FAX communication using IPsec is performed. The operation button 301c and the operation button 301a are in an exclusive relationship for selection, and when the operation button 301c is pressed, the sender record 301 is configured such that transmission-related information is not added to the transmission document.

Concerning the configuration of the communication mode 302, the operation button 302a is provided for designating IP-FAX communication using IPsec when an F code for use in confidential transmission or a PWD (password) for use in password transmission are designated. The F code and the PWD correspond, respectively, to a SUB (sub address) and a PWD which are specified in ITU-T.30 recommendation. The operation button 302b is provided for configuring the communication mode 302 such that IP-FAX communication using IPsec is not designated, irrespective of whether or not an F code and a password are designated.

The settings configured by operating the operation buttons 301a to 301c, 302a, and 302b are stored in the RAM of the system memory 206.

In the case of the illustrated example of the screen, the sender record 301 is configured by the operation buttons 301a and 301b such that when IP-FAX communication using IPsec is performed, the mark indicative of execution of IP-FAX communication using IPsec is added to a document to be transmitted. Further, the communication mode 302 is configured by the operation button 302a such that IP-FAX communication using IPsec is designated when an F code or a PWD is designated.

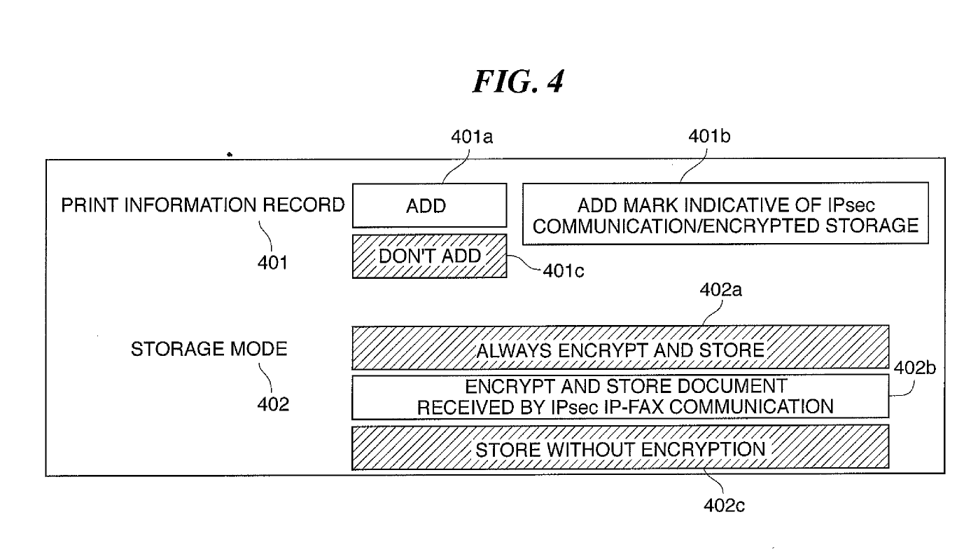

Next, a description will be given of operations by a receiving-side user for configuring the digital multifunction machine 102 (receiving side) for IP-FAX communication with reference to FIG. 4. FIG. 4 is a view showing an example of an IP-FAX communication configuration screen displayed on the digital multifunction machine 102 (receiving side) in FIG. 1. In configuring the receiving-side digital multifunction machine 102 for IP-FAX communication, the IP-FAX communication configuration screen illustrated in FIG. 4 by way of example is displayed on the operating display section 203 in response to user operations input via the operating display section 203. Displayed on the IP-FAX communication configuration screen are a plurality of operation buttons 401a, 401b, and 401c for configuring a print information record 401 and a plurality of operation buttons 402a, 402b, and 402c for configuring a storage mode 402.

Concerning the configuration of the print information record 401, the operation button 401a is provided for selectively setting the recording of reception-related information, such as an acceptance number and a reception-time footer page number, as a footer, in a received document. The operation button 401b can be selected when the operation button 401a has been pressed. When the operation button 401b is pressed, the print information record 401 is configured such that when IP-FAX communication using IPsec is performed and a received document is stored after being encrypted, a mark indicative of the fact is added to the received document. The operation button 401c and the operation button 401a are in an exclusive relationship for selection, and hence when the operation button 401c is pressed, the print information record 401 is configured such that reception-related information is not recorded in the received document.

Concerning the configuration of the storage mode 402, the operation button 402a is provided for selecting a setting of always encrypting and storing received documents. The operation button 402b is provided for selecting a setting of encrypting and storing received documents during IP-FAX communication using IPsec. The operation button 402c is provided for selecting a setting of storing received documents without encrypting the same, irrespective of whether FAX communication is normal IP-FAX communication or IP-FAX communication using IPsec.

The settings thus configured by operating the respective operation buttons 401a to 401c and 402a to 402c are stored in the RAM of the system memory 206.

In the screen illustrated in FIG. 4 by way of example, the print information record 401 is configured by the operation button 401a such that reception-related information is recorded as a footer in a received document. Further, the print information record 401 is configured by the operation button 401b such that when IP-FAX communication using IPsec is performed and a received document is stored after being encrypted, the mark indicative of the fact is added to the received document. Furthermore, the storage mode 402 is configured by the operation button 402b such that a document received during IP-FAX communication using IPsec is stored after being encrypted.

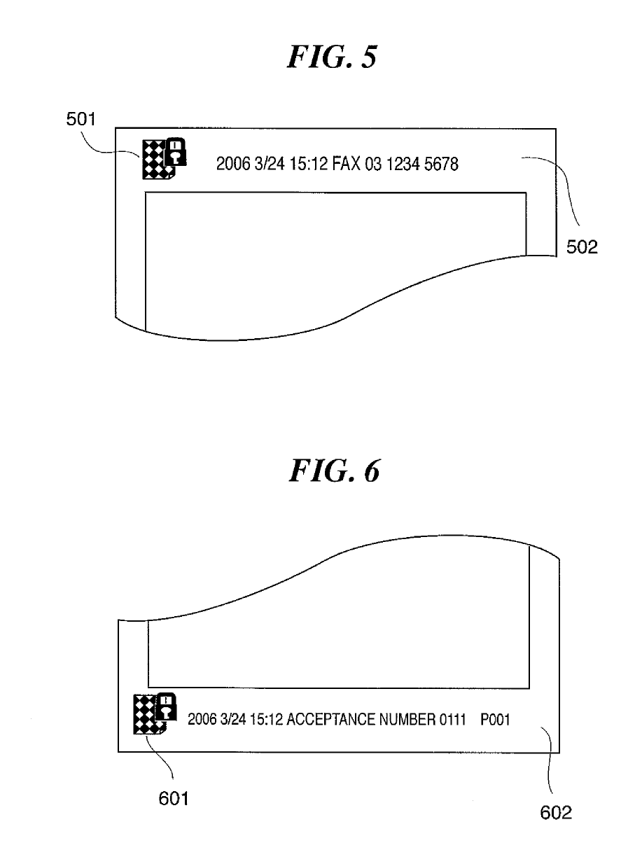

Next, a description will be given of an example of transmission-related information recorded in a transmission document in a case where the sender record 301 is configured for the transmitting-side digital multifunction machine 101 as shown in the screen in FIG. 3, with reference to FIG. 5. FIG. 5 is a view showing the example.

As shown in FIG. 5, the transmission-related information is recorded in the header of a document to be transmitted. The illustrated example corresponds to the settings of the configuration screen as shown in FIG. 3. That is, the sender record 301 is configured such that the transmission-related information is recorded in a transmission document and the mark indicative of the fact is added to the transmission document when IP-FAX communication using IPsec is performed.

More specifically, the mark 501 indicative of execution of IP-FAX communication using IPsec and the transmission-related information 502 (a transmission time and a sender's telephone number) are recorded in the header of the transmission document. The mark 501 is shown by way of example, but is not limited to this. For example, words explicitly indicating that IP-FAX communication using IPsec was performed may be recorded. Further, although in the illustrated example, the transmission time and the sender's telephone number are recorded as the transmission-related information 502, other information, such as an acceptance number and a recipient's telephone number, may be additionally recorded.

Thus, when IP-FAX communication using IPsec is performed, the mark indicative of the fact is recorded in the header of a transmission document, so that it is possible to explicitly indicate that the document was sent by encrypted communication with a high security level.

Next, a description will be given of an example of reception-related information recorded in a received document when the print information record 401 is configured for the receiving-side digital multifunction machine 102, as shown in the screen shown in FIG. 4, with reference to FIG. 6. FIG. 6 is a view showing the example.

As shown in FIG. 6, when the printer section 202 prints a received document, reception-related information is recorded in the footer of the received document. The illustrated example corresponds to the settings of the configuration screen shown in FIG. 4. That is, the print information record 401 is configured such that the reception-related information is recorded, and when IP-FAX communication using IPsec is performed and when the received document is stored after being encrypted, the mark indicative of the facts is added to the received document.

More specifically, a mark 601 indicating that IP-FAX communication using IPsec was performed and the received document has been stored after being encrypted, and reception-related information 602 (a reception time, an acceptance number, and a page number) are recorded in the footer of the received document. The mark 601 is shown by way of example, but not limited to this. Any suitable mark which explicitly indicates that IP-FAX communication using IPsec was performed and that the received document has been stored after being encrypted may be used. Further, although in the illustrated example, the reception time, the acceptance number, and the page number are recorded as the reception-related information 602, this is not limitative, but other information may be additionally recorded.

Thus, by adding the mark indicating that IP-FAX communication using IPsec was performed and that a received document has been stored after being encrypted, it is possible to explicitly indicate that the document was sent by encrypted communication with a high security level, and is then stored after being encrypted.

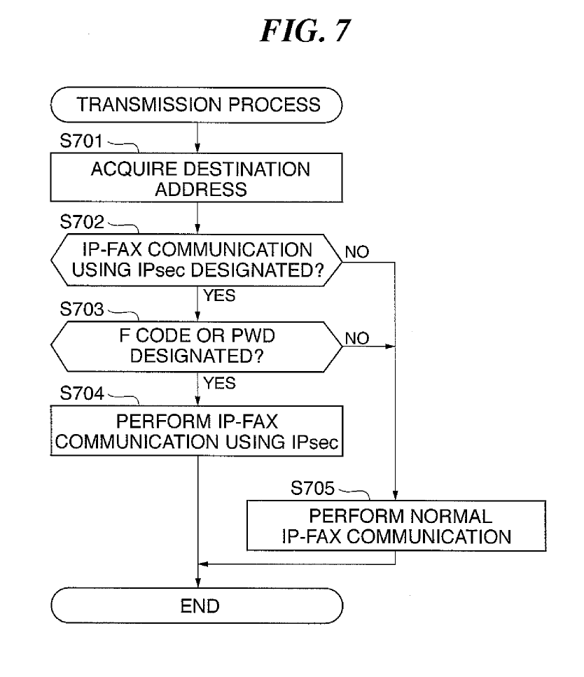

Next, a description will be given of a transmission process in IP-FAX communication, which is executed by the digital multifunction machine 101, with reference to FIG. 7. FIG. 7 is a flowchart of the transmission process in IP-FAX communication, which is executed by the digital multifunction machine 101 appearing in FIG. 1. The process shown in FIG. 7 is carried out based on a program stored in the ROM of the system memory 206.

In sending a document from the digital multifunction machine 101 by IP-FAX communication, the user performs operations for designating the document to be sent and a destination (e.g. a recipient's telephone number or IP address) on the operating display section 203 of the digital multifunction machine 101. Further, the user performs operations for designating an F code or a PWD as required. The information items designated by the respective operations are stored in the RAM of the system memory 206. It is assumed that the settings of the sender record 301 and those of the communication mode 302 have already been configured.

When the user gives an instruction for transmission, first, the system controller 208 acquires the destination stored in the RAM of the system memory 206 (step S701). Then, the system controller 208 determines, based on settings of the communication mode 302 stored in the RAM of the system memory 206, whether or not the execution of IP-FAX communication using IPsec when an F code or a PWD is designated has been set (step S702). If the execution of IP-FAX communication using IPsec when an F code or a PWD is designated has been set, the system controller 208 determines whether or not an F code or a PWD has been designated in association with the acquired destination address (step S703). If an F code or a PWD has been designated in association with the acquired destination address, the system controller 208 instructs the network controller 205 to perform IP-FAX communication using IPsec (step S704), followed by terminating the present process.

First, the network controller 205 instructed to perform IP-FAX communication using IPsec transmits SIP (Session Initiation Protocol) packets encrypted using IPsec and performs call setup for establishing connection to the other side of communication indicated by the acquired destination address. When the connection to the other communication side is established by the call setup operation, the network controller 205 transmits IFP packets encrypted using IPsec and performs capability declaration and image transmission. When the image transmission is completed, the network controller 205 performs call disconnection. At this time, if the recording of transmission-related information and the recording of the mark indicative of execution of IP-FAX communication using IPsec have been set, a header containing the transmission-related information and the mark is added to the transmission document.

If it is determined in the step S703 that an F code or a PWD is not designated, the system controller 208 instructs the network controller 205 to perform normal IP-FAX communication (step S705), followed by terminating the present process.

If it is determined in the step S702 that the execution of IP-FAX communication using IPsec when an F code or a PWD is designated has not been set, i.e. if the button “Don't Designate” (302b) has been selected as a setting of the communication mode 302, the network controller 205 is instructed to perform normal IP-FAX communication (step S705) similarly to the case where the answer to the step S703 is negative (NO).

When instructed to perform normal IP-FAX communication, first, the network controller 205 transmits SIP (Session Initiation Protocol) packets and performs call setup for establishing connection to the other side of communication indicated by the acquired destination address. Then, when the connection to the other communication side is established, the network controller 205 transmits IFP packets and performs capability declaration and image transmission. When the image transmission is completed, the network controller 205 performs call disconnection.

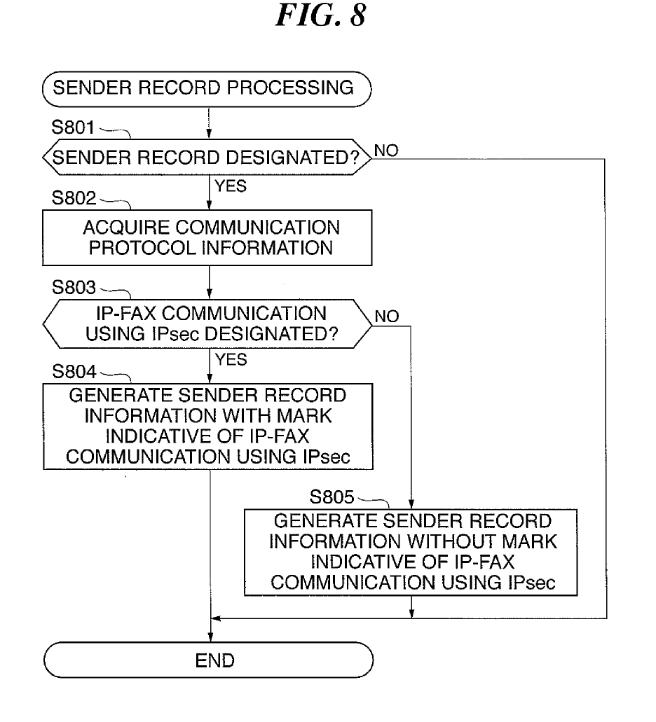

Next, a description will be given of a process for recording the transmission-related information and the mark indicative of execution of IP-FAX communication using IPsec, with reference to FIG. 8. FIG. 8 is a flowchart of the process executed by the digital multifunction machine 101 in FIG. 1, for recording the transmission-related information and the mark indicative of execution of IP-FAX communication using IPsec. The process shown in the flowchart in FIG. 8 is executed by the system controller 208 based on a program stored in the ROM of the system memory 206.

As shown in FIG. 8, first, the system controller 208 refers to information stored in the RAM of the system memory 206 and determines whether or not the addition of a sender record has been designated (step S801). If the addition of a sender record has been designated, the system controller 208 acquires communication protocol information indicative of a protocol in use for current communication (step S802). Then, the system controller 208 determines, based on the acquired communication protocol information, whether or not the current communication is IP-FAX communication using IPsec (step S803). If the IP-FAX communication using IPsec is currently being performed, the system controller 208 generates, as header information, sender record information containing the transmission-related information and the mark indicative of execution of IP-FAX communication using IPsec (step S804). The system controller 208 adds this header information to the header of each page of the transmission document, followed by terminating the present process.

On the other hand, if it is determined in the step S803 that the current communication is not the IP-FAX communication using IPsec mode, the system controller 208 generates, as header information, sender record information containing the transmission-related information alone (step S805). More specifically, header information which does not contain the mark indicative of execution of IP-FAX communication using IPsec, but contains only the transmission-related information is generated. The system controller 208 adds this header information to the header of each page of the transmission document, followed by terminating the present process.

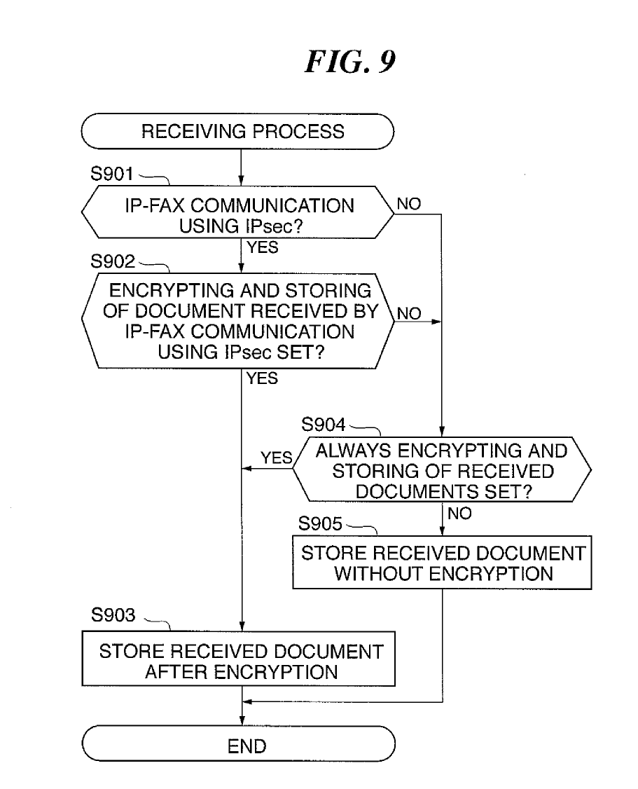

Next, a description will be given of a receiving process in IP-FAX communication, which is executed by the digital multifunction machine 102, with reference to FIG. 9. FIG. 9 is a flowchart of the receiving process in IP-FAX communication, which is executed by the digital multifunction machine 102 appearing in FIG. 1. The process shown in FIG. 9 is carried out based on a program stored in the ROM of the system memory 206.

As shown in FIG. 9, when the digital multifunction machine 102 starts facsimile reception, first, the system controller 208 determines whether or not the current communication is IP-FAX communication using IPsec (step S901). If the current communication is IP-FAX communication using IPsec, the system controller 208 determines whether or not the encrypting and storing of a document received by IP-FAX communication using IPsec has been set (step S902). This setting is made by operating the operation button 402b on the screen illustrated in FIG. 4.

If the encrypting and storing of a received document is set, the system controller 208 causes the encryption unit 209 to encrypt the received document and the HD 210 to store the encrypted document (step S903). The received document encrypted here is a document (encoded document) restored (decrypted) from the IFP packets by the network controller 205. Further, when an F code or a PWD (password) is designated for the encrypted received document, the received document is stored in a reception box provided in the HD 210 in association with the F code or the PWD.

If it is determined in the step S901 that the current communication is not IP-FAX communication using IPsec, the system controller 208 determines whether or not the always encrypting and storing of the received document has been set (step S904). This setting is made by operating the operation button 402a on the screen illustrated in FIG. 4. If the always encrypting and storing of the received documents has been set, the system controller 208 causes the encryption unit 209 to encrypt the received document and the HD 210 to store the encrypted received document (step S903).

On the other hand, the case in which the always encrypting and storing of the received documents is not set is the case where the setting is made by operating the operation button 402c on the screen illustrated in FIG. 4. In this case, the system controller 208 causes the HD 210 to store the received document without encryption thereof (step S905).

If it is determined in the step S902 that the encrypting and storing of a document received by IP-FAX communication using IPsec has not been set, the system controller 208 determines whether or not the always encrypting and storing of a received document has been set (step S904). If the always encrypting and storing of the received document has been set, the system controller 208 causes the encryption unit 209 to encrypt the received document and then the HD 210 to store the encrypted received document (step S903). On the other hand, if the always encrypting and storing of a received document has not been set, the system controller 208 causes the HD 210 to store the received document without encryption thereof (step S905).

Next, a description will be given of a process for outputting a received document encrypted and stored in a reception box within the HD 210, using the printer section 202.

When reading out a received document from the reception box, a user who owns the reception box inputs information (an ID code, a password, etc.) required for authentication of the user, whereby the user is authorized to browse a list of received documents stored in the reception box.

To select a desired encrypted received document from the list of the received documents for printout, the user carries out operations for giving an instruction for printing out the received document and inputting a key for decrypting the document. The selected received document and the input key are delivered to the encryption unit 209, and the encryption unit 209 decrypts the received document into its original form (plaintext) using the input key. Then, the received document decrypted into plaintext is delivered to the printer section 202, and the printer section 202 prints out the received document. In this case, a footer formed according to the settings made on the screen shown in FIG. 4 is recorded in the received document.

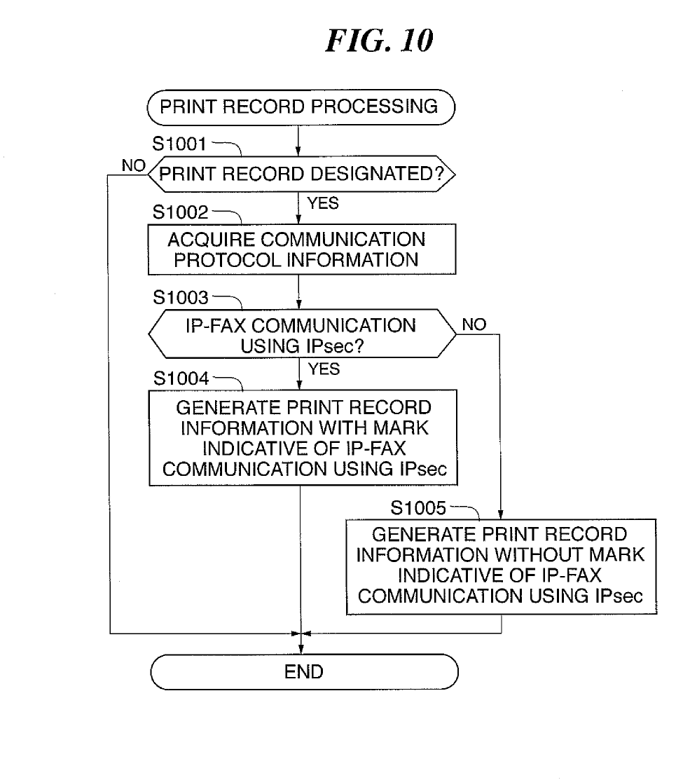

FIG. 10 is a flowchart of a process executed by the digital multifunction machine 102 in FIG. 1, for generating, as footer information, print information record information including the mark indicative of execution of that IP-FAX communication using IPsec. The process shown in the flowchart in FIG. 10 is executed by the system controller 208 based on a program stored in the ROM of the system memory 206.

As shown in FIG. 10, first, the system controller 208 refers to information stored in the RAM of the system memory 206 and determines whether or not the addition of a print information record has been designated (step S1001). If the addition of a print information record has been designated, the system controller 208 acquires communication protocol information indicative of a protocol used in reception (step S1002). Then, the system controller 208 determines, based on the acquired communication protocol information, whether or not the current communication is IP-FAX communication using IPsec (step S1003). If the current communication is IP-FAX communication using IPsec, the system controller 208 generates, as footer information, print information record information containing the mark indicative of execution of IP-FAX communication using IPsec (step S1004). The system controller 208 adds this footer information in the footer of each page of the received document, followed by terminating the present process.

On the other hand, if it is determined in the step S1003 that the current communication is not IP-FAX communication using IPsec, the system controller 208 generates, as footer information, print record information which does not contain the mark indicative of execution of IP-FAX communication using IPsec (step S1005). The system controller 208 adds this footer information in the footer of each page of the received document, followed by terminating the present process.

As described above, the receiving-side facsimile machine having received a document transmitted through IP-FAX communication using IPsec encrypts the received document and then stores the encrypted document in the HD 210, so that it is possible to reliably protect the received document stored in the HD 210 from the danger of being illegally viewed or tampered with. Further, since the document received by IP-FAX communication using IPsec is printed with image information added thereto which is indicative of execution of IP-FAX communication using IPsec, the user can know that the document was transmitted with security.

Although in the present embodiment, it is assumed that the multi-function machine 101 is at the sending side and the multi-function machine 102 at the receiving side, the above description applies to a case where the relationship between the machines 101 and 102 is reversed.

Next, a description will be given of a second embodiment of the present invention. In the second embodiment, similarly to the first embodiment described with reference to FIG. 1, the digital multifunction machines 101 and 102 which are capable of performing IPsec (IP security protocol) communication specified e.g. by RFC 2401 are connected to the IP network 103, such as the Internet or an intranet. The digital multifunction machine 101 is at a transmitting side, and is equipped with a function of transmitting a document to the digital multifunction machine 102 at a receiving side by IP-FAX communication using IPsec. The receiving-side digital multifunction machine 102 is capable of receiving facsimile documents through IP-FAX communication.

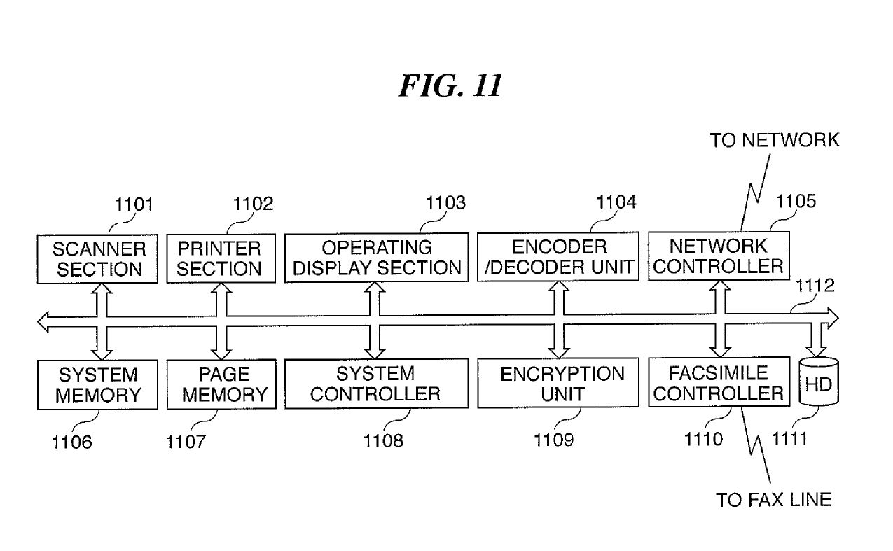

FIG. 11 is a schematic block diagram of the digital multifunction machine according to the second embodiment of the present invention.

Referring to FIG. 11, a scanner section 1101 scans an original in a designated reading mode (in which a sheet size, a resolution, a density, etc. are designated). A printer section 1102 prints a document on sheets and outputs the printed document onto a stacking tray via a sheet discharge apparatus (not shown), such as a finisher. An operation/display section 1103 is operated by a user for configuring various settings. Further, the operating display section 1103 displays the operational status of the digital multifunction machine, and so forth.

An encoder/decoder unit 1104 encodes image information to be transmitted into data and compresses the data, and decodes received compressed data into original image information. A network controller 1105 establishes connection to a LAN to send and receive information to and from another apparatus on the LAN. It should be noted that in encrypted communication using IPsec, the network controller 1105 encrypts transmission packets or decrypts received packets, as required. A system memory 1106 is comprised of a RAM and a ROM, and stores information registered in the digital multifunction machine in advance.

In a page memory 1107, there is loaded one page of image data so as to encode or decode the image data. A system controller 1108 is a microcomputer for monitoring and controlling the operations of the controllers, an HD (hard disk) 1111, and so forth. An encryption unit 1109 encrypts image data before storing the same in the HD 1111.

In storing image data without encryption, data encoded by the encoder/decoder unit 1104 is immediately stored in the HD 1111. In storing image data after encryption, data encoded by the encoder/decoder unit 1104 is further encrypted by the encryption unit 1109 and then stored in the HD 1111. A facsimile controller 1110 is connected to a facsimile line, such as a PSTN line. The facsimile controller 1110 communicates with other facsimile machines or digital multifunction machines via the PSTN line. The HD 1111 is formed by a nonvolatile memory, and stores received documents and scanned documents.

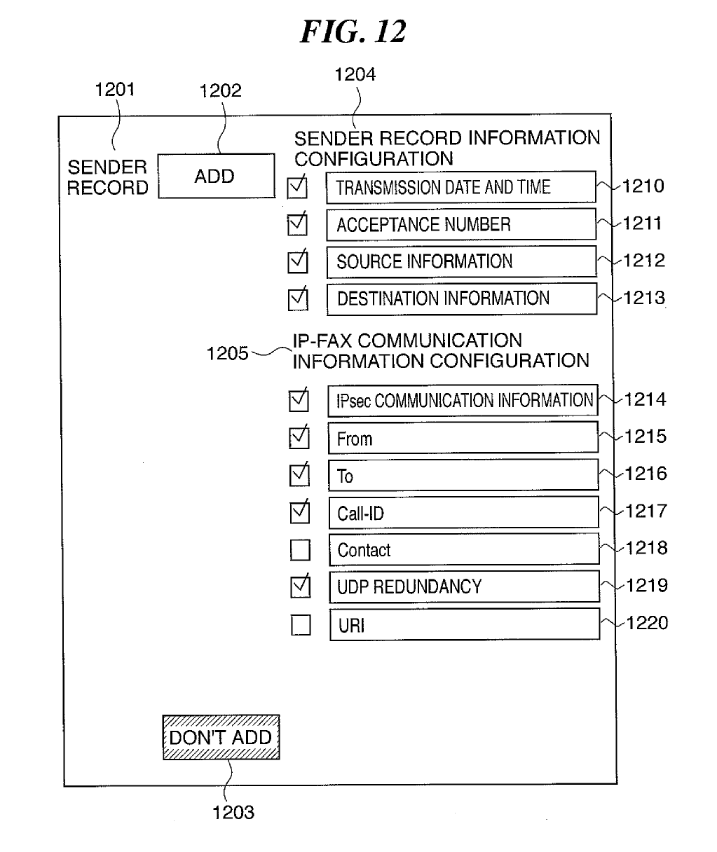

FIG. 12 is a view of a sender record configuration screen displayed on the digital multifunction machine at a sending end, for sender record configuration by a sending-end user.

As shown in FIG. 12, sender record settings can be displayed and changed by the operating display section 1103. The data of changes settings is stored in the RAM of the system memory 1106.

A sender record 1201 indicates a configuration screen for selecting and specifying whether or not to add a sender record to the header of a transmission document, and if a button “Add” 1202 is selected, a sender record (header) containing selected items of a sender record information configuration 1204 and an IP-FAX communication information configuration 1205 is generated. If a button “Don't add” 1203 is selected, a transmission document without a sender record (header) generated for FAX transmission and IP-FAX transmission is sent to a destination (recipient).

The sender record information configuration 1204 defines common settings of sender records to be added in FAX transmission and IP-FAX transmission, and is comprised of items 1210 to 1213 described below.

Transmission date and time 1210 makes it possible to specify whether or not to add information on the transmission date and time of FAX transmission and IP-FAX transmission. If this item is checked, transmission date and time information indicative of a date and time is added to the sender record (header). Acceptance number 1211 makes it possible to specify whether or not to add a number unique to a sender when performing FAX transmission or IP-FAX transmission. If this item is checked, acceptance number information formed by 4 digits of numerals of 0 to 9 is added to the sender record (header).

Source information 1212 makes it possible to specify whether or not to add information including a sender's address registered at the sending end for FAX transmission and IP-FAX transmission. If this item is checked, sender's address information is added to the sender record (header).

Destination information 1213 makes it possible to specify whether or not to add information including a destination address registered at the sending end for FAX transmission and IP-FAX transmission or acquired from a communication protocol used in the communication. If this item is checked, destination address information is added to the sender record (header).

The above-described four items can be set in the sender record information configuration 1204. Information shown in the IP-FAX communication information configuration 1205 is specific to IP-FAX transmission, and is comprised of items 1214 to 1220 described below.

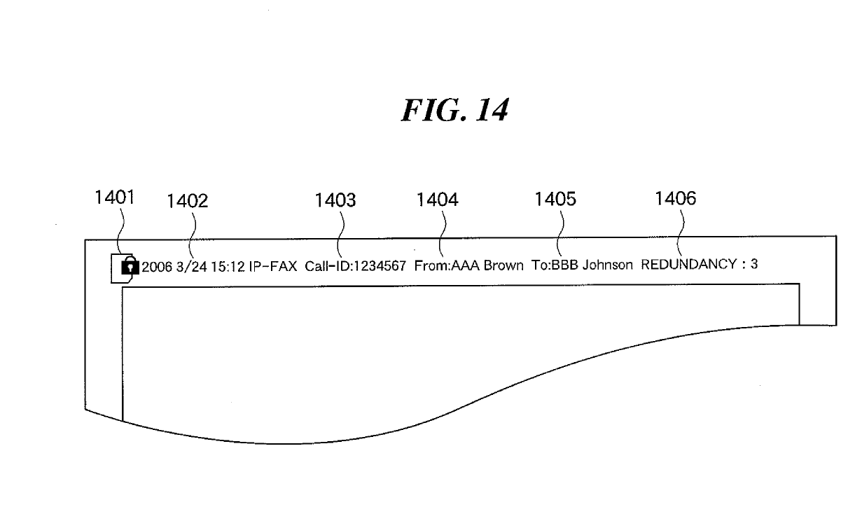

IPsec communication information 1214 makes it possible to specify whether or not to add information formed by a mark, a symbol, or a character string indicative of execution of IP-FAX communication using IPsec (IPsec communication) for IP-FAX transmission. If this item is checked, a mark (described hereinafter with reference to FIG. 14) indicative of execution of IPsec communication is added to the sender record (header).

“From” 1215 makes it possible to specify whether or not to add “from” header information in a SIP message, when performing IP-FAX transmission. If this item is checked, “from” header information comprised of an publisher's name and SIP URL information is added to the sender record (header).

“To” 1216 makes it possible to specify whether or not to add “to” header information in a SIP message for IP-FAX transmission. If this item is checked, “to” header information comprised of a recipient's name and SIP URL information is added to the sender record (header).

Call-ID 1217 makes it possible to specify whether or not to add Call-ID header information in a SIP message for IP-FAX transmission. If this item is checked, Call-ID header information associated with a session is added to the sender record (header).

Contact 1218 makes it possible to specify whether or not to add contact header information in a SIP message for IP-FAX transmission. If this item is checked, contact header information having URL information for enabling the user to make direct contact is added to the sender record (header). UDP redundancy 1219 makes it possible to specify whether or not to add redundancy in information on network transport layer UDP for IP-FAX transmission. If this item is checked, redundancy information indicative of the number of data redundancies in view of packet loss in network communication is added to the sender record (header)

URI 1220 makes it possible to specify whether or not to add URI information in a SIP message for IP-FAX transmission. If this item is checked, URI address information indicative of a real destination address is added to the sender record (header).

As described above, the user can designate items in the sender record 1201 before transmitting a document, to thereby record information on the designated items in the sender record (header) of the transmission document.

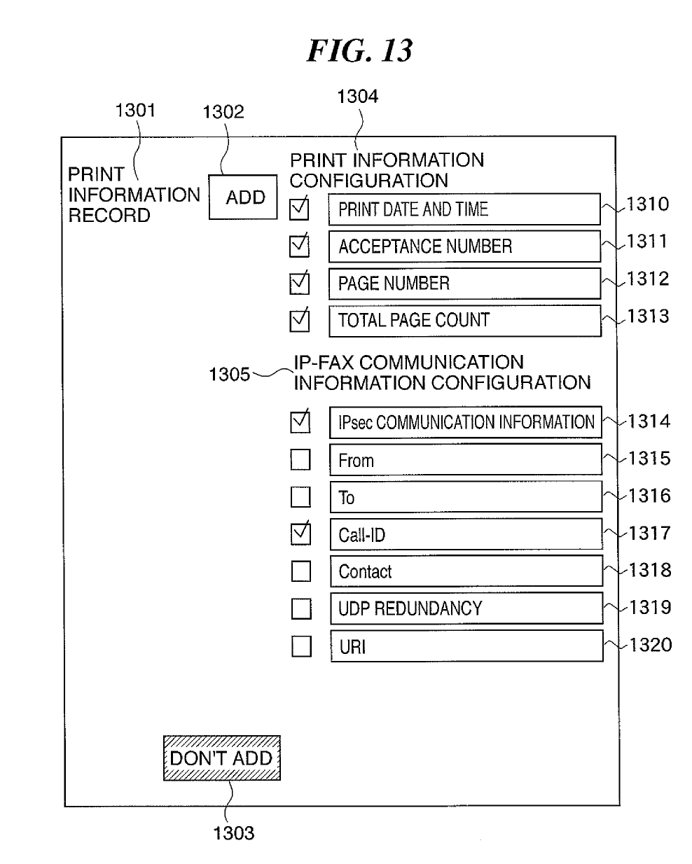

FIG. 13 is a view of a print information record configuration screen displayed on the digital multifunction machine at the receiving end, for print information record configuration by a receiving-end user.

As shown in FIG. 13, print information record settings can be displayed and changed by the operating display section 1103. The data of changed settings is stored in the RAM of the system memory 1106.

A print information record 1301 indicates a configuration screen for selecting and specifying whether or not to add a print information record to the footer of a received document in printing the same. If a button “Add” 1302 is selected, a print information record (footer) containing information on selected items of a print information configuration 1304 and an IP-FAX communication information configuration 1305 is generated and printed. If a button “Don't add” 1303 is selected, the received document is printed without a print information record (footer).

The print information configuration 1304 defines common settings of print information records (footers) to be added to a document when printing the same, and is comprised of items 1310 to 1313 described below.

Print date and time 1310 makes it possible to specify whether or not to add information on a print date and time when a document is printed. If this item is checked, print date and time information indicative of a date and time is added to the print information record (footer).

Acceptance number 1311 makes it possible to specify whether or not to add a number unique to a document to be printed. If this item is checked, acceptance number information formed by 4 digits of numerals of 0 to 9 is added to the print information record (footer).

Page number 1312 makes it possible to specify whether or not to add page number information of a print document. If this item is checked, page number information indicative of a page number of a print document is added to the print information record (footer).

Total page count 1313 makes it possible to specify whether or not to add total page count information on the total page count of a print document. If this item is checked, total page count information on the print document is added to the print information record (footer).

The above-described four items can be set in the print information configuration 1304.

The IP-FAX communication information configuration 1305 is specific to an IP-FAX received document, and is comprised of items 1314 to 1320 described below.

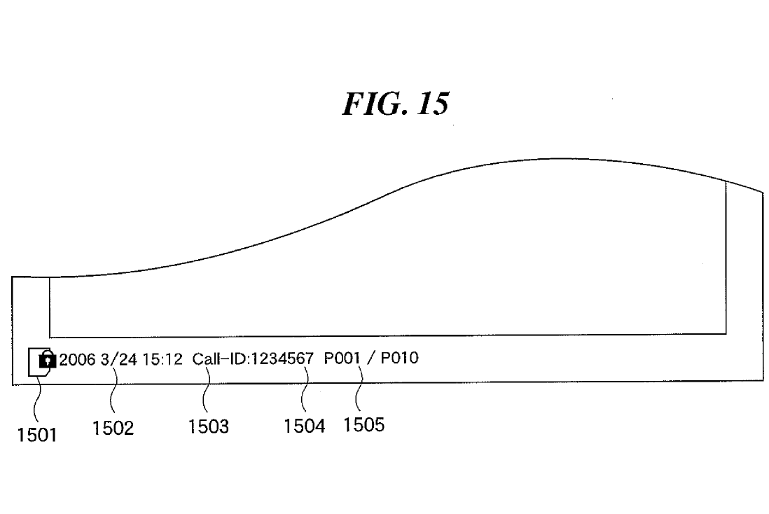

IPsec communication information 1314 makes it possible to specify whether or not to add information formed by a mark, a symbol, or a character string indicative of execution of IP-FAX communication using IPsec (IPsec communication) when the document was received by IP-FAX communication. If this item is checked, a mark (described hereinafter with reference to FIG. 15) indicative of execution of IPsec communication is added to the print information record (footer).

“From” 1315 makes it possible to specify whether or not to add “from” header information in a SIP message upon IP-FAX reception. If this item is checked, “from” header information comprised of an publisher's name and SIP URL information is added to the print information record (footer).

“To” 1316 makes it possible to specify whether or not to add “to” header information in a SIP message upon IP-FAX reception. If this item is checked, “to” header information comprised of a recipient's name and SIP URL information is added to the print information record (footer).

Call-ID 1317 makes it possible to specify whether or not to add Call-ID header information in a SIP message upon IP-FAX reception. If this item is checked, Call-ID header information associated with a session is added to the print information record (footer).

Contact 1318 makes it possible to specify whether or not to add contact header information in a SIP message upon IP-FAX reception. If this item is checked, contact header information having URL information for enabling a user to make direct contact is added to the print information record (footer).

UDP redundancy 1319 makes it possible to specify whether or not to add redundancy in information on network transport layer UDP upon IP-FAX reception. If this item is checked, redundancy information indicative of the number of data redundancies in view of packet loss in network communication is added to the print information record (footer).

URI 1320 makes it possible to specify whether or not to add URI information in a SIP message upon IP-FAX reception. If this item is checked, URI address information indicative of a real destination address is added to the print information record (footer).

As described above, by designating items in the print information record 1301, the user can cause information on the designated items to be entered in the print information record (footer) of the printed document.

FIG. 14 is a view showing an example of the sender record (header) added to a transmission document when IPsec communication is performed between the digital multifunction machines according to the second embodiment.

More specifically, in the illustrated example, it is assumed that in the sender record 1201, the button “Add” 1202 is selected, and the items of Transmission date and time 1210, Acceptance number 1211, Source information 1212, Destination information 1213, IPsec communication information 1214, “From” 1215, “To” 1216, Call-ID 1217, and UPD redundancy 1219 are selected by user configuration.

IPsec communication mark 1401 indicates execution of IPsec communication. The user can recognize from the mark recorded in the sender record (header) in a received document that the document was received by high-security path-encrypted communication.

Transmission date and time 1402 is shown when the transmission date and time 1210 is selected. Call-ID 1403 shows an acceptance number or a call ID. In the illustrate example, the Call-ID 1217 and acceptance number 1211 are both set for display, and at the same time the priority of Call-ID over the acceptance number is specified, so that a call ID is shown.

“From” 1404 shows sender information or “from” information. In the present embodiment, the source information 1212 and “From” 1215 are both set for display, and at the same time, the priority of “From” over sender information is specified, so that the “from” information is displayed.

“To” 1405 shows destination information or “to” information or URI. In the illustrated example, the destination information 1213 and the “To” 1216 are both designated for display, the URI 1220 is not designated, and the priority setting of URI>To>destination information is specified, so that the “to” information is displayed.

Redundancy 1406 shows redundancy in network transport layer UDP information. In the illustrated example, since the URI 1220 is not set for display, redundancy in UDP information is displayed.

Contact, which is not displayed in the illustrated example, is to be displayed behind Redundancy 1406 in the sender record (header) when Contact 1218 is selected. Although in the present embodiment, one of an acceptance number and a call ID, and one of URI, “to” information, and sender information are configured to be entered in respective identical areas according to priority, they may be entered together side by side.

FIG. 15 is a view showing an example of a print information record (footer) added to a received document when the document received when IPsec communication is performed between the digital multifunction machines according to the second embodiment is printed.

More specifically, in the illustrated example, it is assumed that in the print information record 1301, the button “Add” 1302 is selected, and the items of Print date and time 1310, Acceptance number 1311, Page number 1312, Total page count 1313, IPsec communication information 1314, and Call-ID 1317 are selected by user configuration.

Referring to FIG. 15, an IPsec communication mark 1501 indicates execution of IPsec communication. The user can recognize from the mark recorded in print information record (footer) in a printed document that the document was received by path-encrypted high-security communication.

Print date and time 1502 is displayed when Print date and time 1310 has been selected. Call-ID 1503 shows an acceptance number or a call ID. In the illustrated example, Call-ID 1317 and Acceptance number 1311 are both set for display, and the priority of Call-ID over acceptance number is specified, so that the call ID is displayed.

Page number 1504 shows a page number of the print document. Total page count 1505 shows the total number of pages of the print document.

“From” information, “To” information, Contact information, UDP redundancy information, and URI information, which are not displayed in the illustrated example, are to be displayed when From 1315, To 1316, Contact 1318, UDP redundancy 1319, and URI 1320 are selected, respectively. Although in the illustrated example, one of an acceptance number and a call ID, and one of URI, “To” information, and sender information are configured to be entered in respective identical areas according to priority, they may be entered together side by side.

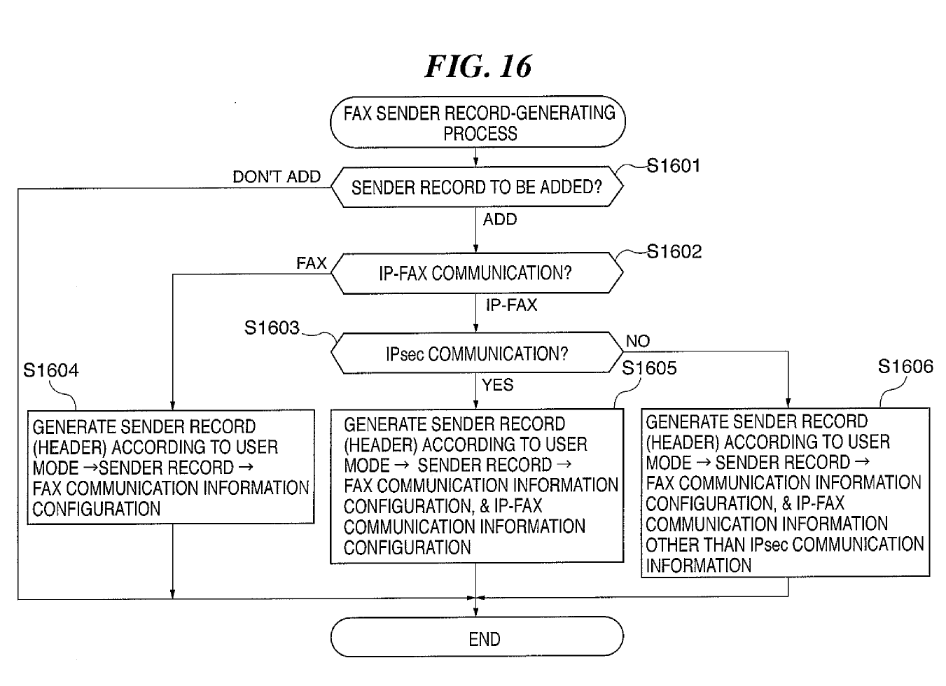

FIG. 16 is a flowchart of a FAX sender record-generating process executed by the digital multifunction machine at the sending end.

The present process is executed by the system controller 1108 appearing in FIG. 11.

As shown in FIG. 16, first, in a step S1601, information on the sender record 1201 stored in the RAM of the system memory 1106 in the digital multifunction machine in FIG. 11 is acquired, and it is determined whether or not the button “Add” 1202 has been selected. If the button “Add” 1202 has been selected, the process proceeds to a step S1602. If the button “Don't add” 1203 has been selected, the process is terminated without adding a sender record (header).

In the step S1602, it is determined whether or not the current communication is IP-FAX communication via the network controller 1105 or FAX communication via the facsimile controller 1110. If the current communication is IP-FAX communication, the process proceeds to a step S1603, whereas if the current communication is FAX communication, the process proceeds to a step S1604.

In the step S1603, it is determined whether or not the current IP-FAX communication via the network controller 1105 is IPsec communication in which communication path is encrypted, i.e. IP-FAX communication using IPsec. If the current communication is IPsec communication, the process proceeds to a step S1605, whereas if the current communication is not IPsec communication, the process proceeds to a step S1606.

In the step S1604, since the current communication is FAX communication, a sender record (header) information is generated according to the settings of the sender record information configuration 1204 stored in the RAM of the system memory 1106.

More specifically, information on items selectively set by Transmission date and time 1210, Acceptance number 1211, Source information 1212, and Destination information 1213 is acquired via the facsimile controller 1110 to generate sender record (header) information, and the generated sender record information is added as an image to the top of a page of a transmission document loaded in the page memory 1107.

In the step S1605, since the current communication is IP-FAX communication using IPsec, sender record (header) information is generated according to the settings of the sender record information configuration 1204 and the IP-FAX communication information configuration 1205 in the sender record 1201, which are stored in the RAM of the system memory 1106.

More specifically, information on items selected in the sender record information configuration 1204 and the IP-FAX communication information configuration 1205 are acquired via the network controller 1105 to thereby generate sender record (header) information, and the generated sender record information is added as an image to the top of a page of a transmission document loaded in the page memory 1107.

Further, in the step S1606, since the current communication is IP-FAX communication not using IPsec, sender record (header) information without IPsec communication information is generated according to the settings of the sender record information configuration 1204 and the IP-FAX communication information configuration 1205.

More specifically, information on items selected in the sender record information configuration 1204 and the IP-FAX communication information configuration 1205 is acquired via the network controller 1105 to thereby generate sender record (header) information, and the generated sender record information is added as an image to the top of a page of a transmission document loaded in the page memory 1107. Thereafter, the network controller 1105 encrypts IP packets generated based on image data to be transmitted, according to IPsec protocol, and transmits the IP packets to a receiving-end terminal designated as a destination.

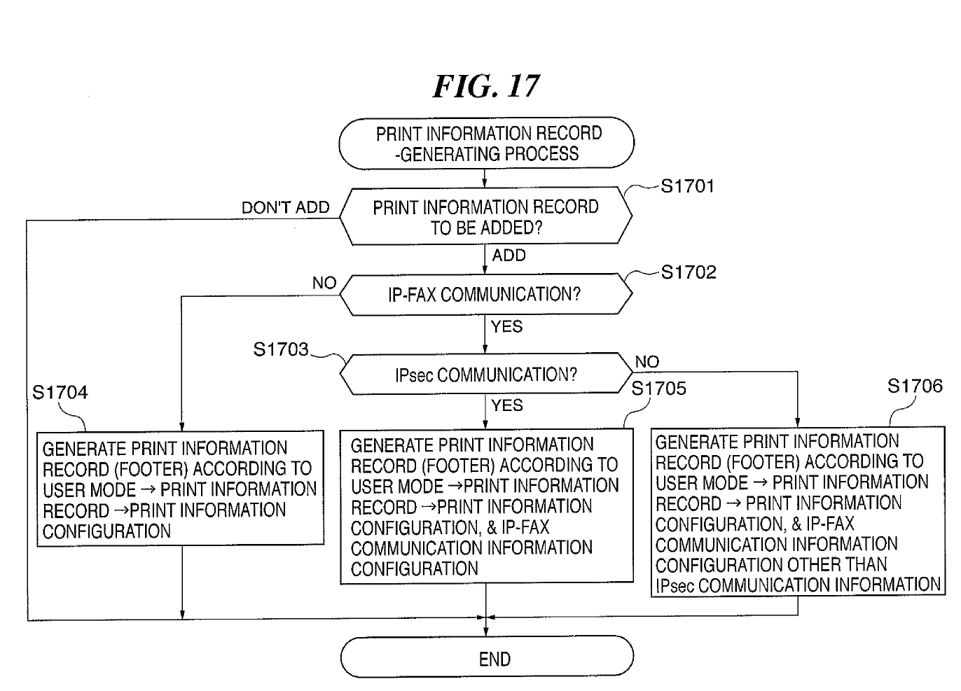

FIG. 17 is a flowchart of a print information record-generating process executed by the digital multifunction machine at the receiving end.

The present process is executed by the system controller 1108 appearing in FIG. 11.

As shown in FIG. 17, first, in a step S1701, information of the print information record 1301 stored in the RAM of the system memory 1106 in the digital multifunction machine 102 is acquired, and it is determined whether or not the button “Add” 1302 has been selected. If the button “Add” 1302 has been selected, the process proceeds to a step S1702. If the button “Don't add” 1303 has been selected, the process is terminated without adding a print information record (footer).

In the step S1702, it is determined whether or not the received document is a document received via the network controller 1105 by IP-FAX communication or a document received via the facsimile controller 1110 by FAX communication. If the document has been received by IP-FAX communication, the process proceeds to a step S1703, whereas if the document has been received by FAX communication, the process proceeds to a step S1704.

In the step S1703, it is determined whether or not the IP-FAX communication performed via the network controller 1105 for receiving the document was IP-FAX communication using IPsec in which a communication path is encrypted, and if the IP-FAX communication was IPsec communication, the process proceeds to a step S1705, whereas the IP-FAX communication was not IPsec communication, the process proceeds to a step S1706.

On the other hand, in the step S1704, since the document was received by FAX communication, a print information record (footer) information is generated according to the settings of the print information configuration 1304 in the print information record 1301 stored in the RAM of the system memory 1106.

More specifically, information on items selectively set by Print date and time 1310, Acceptance number 1311, Page number 1312, and Total page count 1313 is acquired via the facsimile controller 1110 to thereby generate print information record (footer) information, and the generated print information record (footer) information is added as an image to the bottom of a page of a transmission document loaded in the page memory 1107.

On the other hand, in the step S1705, since the document was received by IP-FAX communication using IPsec, print information record (footer) information is generated according to the settings of the print information configuration 1304 and the IP-FAX communication information configuration 1305 in the print information record 1301.

More specifically, information on items selectively set in the print information configuration 1304 and the IP-FAX communication information configuration 1305 is acquired via the network controller 1105 to thereby generate print information record (footer) information, and the generated print information record information is added as an image to the bottom of a page of a print document loaded in the page memory 1107.

Further, in the step S1706, since the document was received by IP-FAX communication not using IPsec, print information record (footer) information without IPsec communication information is generated according the settings of the print information configuration 1304 and the IP-FAX communication information configuration 1305.

More specifically, information on items selectively set in the print information configuration 1304 and the IP-FAX communication information configuration 1305 are acquired via the network controller 1105 to thereby generate print information record (footer) information, and the generated print information record information is added as an image to the bottom of a page of the print document loaded in the page memory 1107. Thereafter, the page of the print document is printed out by the printer section 1102.

It is to be understood that the present invention may also be also accomplished by supplying a system or an apparatus with a storage medium in which a program code of software, which realizes the functions of either of the above described embodiments is stored, and causing a computer (or CPU or MPU) of the system or apparatus to read out and execute the program code stored in the storage medium.

In this case, the program code itself read from the storage medium realizes the functions of either of the above described embodiments, and therefore the program code and the storage medium in which the program code is stored constitute the present invention.

Examples of the storage medium for supplying the program code include a floppy (registered trademark) disk, a hard disk, a magnetic-optical disk, an optical disk, such as a CD-ROM, a CD-R, a CD-RW, a DVD-ROM, a DVD-RAM, a DVD-RW, or a DVD+RW, a magnetic tape, a nonvolatile memory card, and a ROM. Alternatively, the program may be downloaded via a network.

Further, it is to be understood that the functions of either of the above described embodiments may be accomplished not only by executing the program code read out by a computer, but also by causing an OS (operating system) or the like which operates on the computer to perform a part or all of the actual operations based on instructions of the program code.

Further, it is to be understood that the functions of either of the above described embodiments may be accomplished by writing a program code read out from the storage medium into a memory provided on an expansion board inserted into a computer or a memory provided in an expansion unit connected to the computer and then causing a CPU or the like provided in the expansion board or the expansion unit to perform a part or all of the actual operations based on instructions of the program code.

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures and function.

This application claims the benefit of Japanese Applications No. 2006-316115, filed Nov. 22, 2006, and No. 2007-14196, filed Jan. 24, 2007 which are hereby incorporated by reference herein in their entirety.

What is claimed is:

1. A communication apparatus which is capable of performing communication via an IP network, comprising:
an image information input unit configured to input image information to be transmitted;
a determining unit configured to determine whether or not confidential transmission of the input image information has been designated by a user; and
a transmission unit configured to be operable when it is determined that the confidential transmission of the input image information has been designated, to encrypt the input image information using IPsec and transmit the encrypted image information, whereas when it is determined that the confidential transmission of the input image information has not been designated, to transmit the input image information without encryption.

2. A communication apparatus as claimed in claim 1, further comprising an information-adding unit configured to add additional information indicative of execution of encrypted transmission using IPsec to the input image information when the input image information is to be encrypted and transmitted using IPsec.

3. A communication apparatus as claimed in claim 1, further comprising an image reading unit,
wherein said image information input unit inputs image information read by said image reading unit, as the image information to be transmitted.

4. A communication apparatus which is capable of performing communication via an IP network, comprising:
a reception unit configured to receive image information transmitted via the IP network;
an encryption unit configured to encrypt the received image information;
a storage unit configured to store the received image information;
a determining unit configured to determine whether or not the received image information was transmitted using IPsec; and
a controller unit configured to be operable when said determining unit determines that the received image information was transmitted using IPsec, to cause the image information to be stored in said storage unit after being encrypted by said encryption unit, whereas when said determining unit determines that the received image information was transmitted without using IPsec, to cause the image information to be stored in said storage unit without being encrypted by said encryption unit.

5. A communication apparatus as claimed in claim 4, wherein said reception unit receives the image information transmitted after being encrypted using IPsec.

6. A communication apparatus which is capable of performing communication with a receiving apparatus connected to the communication apparatus via an IP network, comprising:
an encryption unit configured to encrypt image information to be transmitted to the receiving apparatus;
a determining unit configured to determine whether or not the image information is to be encrypted by said encryption unit for transmission;
an information-adding unit configured to be operable when said determining unit determines that the image information is to be encrypted by said encryption unit for transmission, to add additional information indicative of execution of encrypted transmission to the image information; and
a transmission unit configured to transmit the image information having the additional information added thereto and encrypted by said encryption unit to the receiving apparatus.

7. A communication apparatus as claimed in claim 6, further comprising a generation unit configured to generate the additional information,
wherein said information-adding unit adds the additional information generated by said generation unit to a header area in the image information.

8. A communication apparatus as claimed in claim 6, wherein said transmission unit performs real-time internet facsimile communication in accordance with ITU-T Recommendation T.38, to transmit the image information.

9. A communication apparatus as claimed in claim 6, wherein said encryption unit encrypts IP packets generated based on the image information, in accordance with an IPsec protocol.

10. A communication apparatus which is capable of performing communication with a transmitting apparatus connected to the communication apparatus via an IP network, comprising:
a reception unit configured to receive image information transmitted from the transmitting apparatus;
a decryption unit configured to decrypt the image information received by said reception unit when the image information was encrypted;
a determining unit configured to determine whether or not the image information received by said reception unit was encrypted;
an information-adding unit configured to be operable when it is determined by said determining unit that the image information was encrypted, to add additional information indicative of execution of encrypted transmission to the image information decrypted by said decryption unit; and
a printing unit configured to print the image information having the additional information added thereto.

11. A communication apparatus as claimed in claim 10, further comprising a generation unit configured to generate the additional information,
wherein said information-adding unit adds the additional information generated by said generation unit to a footer area in the image information.

12. A communication apparatus as claimed in claim 10, wherein said reception unit performs real-time internet facsimile communication in accordance with ITU-T Recommendation T.38, to receive the image information.

13. A communication apparatus as claimed in claim 10, wherein said decryption unit decrypts encrypted IP packets generated based on the image information, in accordance with an IPsec protocol.
